(19) United States
(12) Patent Application Publication
(10) Pub. No.: US 2019/0001620 A1
(43) Pub. Date: Jan. 3, 2019

(54) NOVEL METHOD OF MAKING DECORATIVE ARTICLES

(71) Applicant: Kiao Wild Jewellery Holding Company Limited, Hong Kong (CN)

(72) Inventor: Yin Sang Lam, Hong Kong (CN)

(73) Assignee: Kiao Wild Jewellery Holding Company Limited, Hong Kong (CN)

(21) Appl. No.: 15/636,638

(22) Filed: Jun. 29, 2017

(51) Int. Cl. B32B 7/04; B32B 15/04; B32B 27/04; B32B 7/12; C25D 5/34

(52) U.S. Cl. CPC B32B 7/04; B32B 15/043; B32B 2451/00; B32B 7/12; C25D 5/34; B32B 27/04

(57) ABSTRACT

Provided herein is a method of making decorative articles such as seashells comprising the steps of providing an article; coating a first transparent protecting layer on the article; painting a decorative pattern layer on the first transparent protecting layer with an adhesive; covering the decorative pattern layer by metal powder to form a metal powder layer on the decorative pattern layer; curing partially or completely the adhesive to fix the metal powder on the decorative pattern layer; and forming at least one continuous metal layer on the metal powder layer by an electroplating method. Also provided herein are decorative articles such as seashells made by the methods disclosed herein.

### FIELD OF THE INVENTION

This invention relates to methods of making decorative articles such as seashells by electroplating and decorative articles made by the methods disclosed herein.

### BACKGROUND OF THE INVENTION

An attractive, aesthetically appealing appearance is needed in decorative articles such as seashells and other articles. Seashells have been used by humans for many different purposes throughout history and pre-history. Because of their rich and delicate textures and colors on their surface, whole seashells or parts of seashells have been used as decorative articles, jewelry and other forms of adornment since prehistoric times.

The appearance of seashells can be enhanced by modern processes, such as spray painting with paints or dyeing with chemical dyes. However, spray painting and dyeing processes have their drawbacks. Spray painting can provide colors to the back of the seashell but not its front, while dyeing can cause harm and uneven dyeing because of varied cell density of the seashell.

Electroplating process can also enhance the appearance of seashells by depositing on the surface of the seashells a metal layer having a beautiful metal luster. However, the metal layer generally tends to peel off from the surface of the seashells due to poor adhesion between the seashell surface and a protecting layer beneath the metal layer.

In view of the above, there is a need for an improved method for making decorative articles such as seashells with durable metal layers that have a strong adhesion with the surface of the articles such as seashells and will not peel off from their surfaces.

### SUMMARY OF THE INVENTION

Provided herein are novel methods of making decorative articles such as seashells by electroplating, wherein the methods provide decorative articles such as seashells with one or more durable metal layers that have a strong adhesion with the surface of the seashells. Also provided herein are decorative articles such as seashells made by the novel methods disclosed herein.

In one aspect, provided herein is a method of making a decorative article, comprising the steps of:

a) providing an article (e.g., a seashell);

b) coating a first transparent protecting layer on the article;

c) painting a decorative pattern layer on the first transparent protecting layer with an adhesive;

d) covering the decorative pattern layer by metal powder to form a metal powder layer on the decorative pattern layer;

e) curing partially or completely the adhesive to fix the metal powder on the decorative pattern layer; and

f) forming at least one continuous metal layer on the metal powder layer by an electroplating method.

In some embodiments, the electroplating method is electrochemical deposition, pulse electroplating, brush electroplating, or electroless deposition.

In certain embodiments, the adhesive is a one-part adhesive, a 2-part adhesive or a combination thereof. In some embodiments, the one-part adhesive is a heat curing adhesive, moisture curing adhesive, a UV light curing adhesive, or a combination thereof. In other embodiments, the 2-part adhesive is cured at room temperature. In further embodiments, the adhesive is a 2-part adhesive and wherein the curing step e) is done at room temperature for a time period from 30 minutes to 8 hours.

In some embodiments, the metal powder is gold powder, silver powder, copper powder, or a combination thereof.

In certain embodiments, the metal in the continuous metal layer is copper, silver, gold, palladium, platinum, rhodium or a combination thereof.

In some embodiments, there are two or more continuous metal layers, and wherein the metals in the continuous metal layers are different.

In certain embodiments, the method disclosed herein further comprises cleaning the article before the coating step b).

In some embodiments, the covering step d) is done by sprinkling or spraying the metal powder onto the decorative pattern layer. In certain embodiments, the sprinkling is done by hand, a hand tool or a scattering machine. In other embodiments, the sprinkling or spraying step is repeated 1-5 times before the curing step e).

In certain embodiments, the article with the metal powder layer is cleaned before the forming step f). In some embodiments, the cleaning is done by solvent cleaning, hot alkaline detergent cleaning, electro-cleaning, acid treatment, or a combination thereof.

In some embodiments, the area of the decorative pattern layer is less than about 10%, less than about 20%, less than about 30%, less than about 40%, less than about 50%, less than about 60%, or less than about 80% of the total surface area of the article.

In certain embodiments, the thickness of the continuous metal layer is from 0.05 microns to 500 microns.

In some embodiments, the average particle size of the metal powder is less than 0.5 mm. In certain embodiments, the average particle size of the metal powder is greater than or less than the thickness of the decorative pattern layer.

In certain embodiments, the method disclosed herein further comprises applying a second transparent protecting layer on the article after the forming step f).

In another aspect, provided herein is a decorative article such as seashell prepared by the methods disclosed herein.

### BRIEF DESCRIPTION OF THE DRAWINGS

FIG. 1 depicts a cross section view of a decorative article without a metal powder layer.

FIG. 2 depicts a cross section view of a first embodiment of the decorative article disclosed herein.

FIG. 3 depicts an exploded view of a second embodiment of the decorative article disclosed herein, wherein the decorative article has, inter alia, a decorative pattern layer, a metal powder layer and a top protecting layer in the form of letter A.

### DETAILED DESCRIPTION OF THE INVENTION

In one aspect, provided herein is a method of making a decorative article such as a decorative seashell, comprising the steps of:

a) providing a article;

b) coating a first transparent protecting layer on the seashell;

c) painting a decorative pattern layer on the first transparent protecting layer with an adhesive;

d) covering the decorative pattern layer by metal powder to form a metal powder layer on the decorative pattern layer;

e) curing partially or completely the adhesive to fix the metal powder on the decorative pattern layer; and

f) forming at least one continuous metal layer on the metal powder layer by an electroplating method.

The decorative article can be in any shape and dimension suitable for decorative purposes. In some embodiments, the decorative article is in the shape and dimension of any conventional jewelry. The decorative article disclosed herein can be in any shape and dimension suitable for personal jewelry and/or household decoration. In certain embodiments, the decorative article is a natural article such as seashells, a man-made article or a combination thereof. In further embodiments, the decorative article is a man-made article prepared by 3D printing, injection molding, extrusion or casting. In some embodiments, the decorative article is in the shape and dimension of a seashell, star fish, fruit, or vegetable.

The decorative article may be made of any rigid non-electroconductive material. Some non-limiting examples of suitable rigid material include polymers (e.g., thermoplastics, elastomers, and thermosets), ceramics, compositions comprising one or more polymers and/or one or more ceramics, laminates, wood, bone, jade, stones (e.g., precious stones and non-precious stones), and combinations thereof. In some embodiments, the method disclosed herein does not include or use flowers, leaves, and other natural and/or man-made objects which do not have a hard and rigid surface.

In some embodiments, the decorative article includes decorative seashells. The seashells for this invention include all hard, protective outer layer created by an animal that lives in the sea. Some non-limiting examples of suitable seashells are molluscan seashells and other types of seashells. Some non-limiting examples of molluscan seashells include bivalve seashells, gastropod seashells, polyplacophoran seashells, and cephalopod seashells.

The seashells for this invention also include seashell-shaped articles made of the rigid non-electroconductive materials disclosed herein. The seashells used herein can be in various decorative size suitable for personal jewelry and/or household decoration.

The seashell may be cleaned before the coating step b) to remove any contamination and loose particles or pieces on the surface of the seashell so as to enhance the appearance of the seashell and/or increase the adhesion between the first transparent protecting layer and the seashell. The cleaning can be done with any conventional chemical method (e.g., using detergents, acids, bases, and/or solvents), mechanical method (e.g., using a washer or spraying with water), physical method (e.g., using an ultrasound bath) or a combination thereof. In some embodiments, the cleaning before the coating step b) is done by solvent cleaning, hot alkaline detergent cleaning, acid treatment, or a combination thereof.

The first transparent protecting layer is for protecting non-plating area of the seashell during the electroplating process. In some embodiments, the first transparent protecting layer is or comprises a transparent polymer or a ceramic coating. The transparent polymer or ceramic coating can be neat without a solvent or in the form of a solution with a solvent. Any polymer (e.g., thermoplastics and thermosets) or polymer composition that is amorphous (i.e., transparent) and has a glass transition temperature (T_{g}) higher than room temperature (i.e., non-tacky at room temperature) can be used as the first transparent protecting layer. In certain embodiments, the first transparent protecting layer is or comprises a thermoset. In further embodiments, the first transparent protecting layer does not comprise an elastomer or an adhesive.

In certain embodiments, the first transparent protecting layer is or comprises a transparent epoxy resin such as KRAFTKOTE™ transparent polymer resin (available from Kirkside Products Pty. Ltd., Osborne Park, Western Australia, Australia), and Aristocrat Liquid Glass (available from B. D. Classic Enterprizes, Inc., Santa Fe Springs, Calif., USA). In further embodiments, the first transparent protecting layer is or comprises a transparent acrylic resin such as KRALON™ transparent acrylic resin (available from Krylon Products Group, Cleveland, Ohio). In still further embodiments, the first transparent protecting layer is or comprises a transparent ceramic coating such as CERAKOTE™ transparent ceramic coating (available from NIC Industries, Inc., White City, Oreg.).

In certain embodiments, the T_{g} of the first transparent protecting layer is higher than 30° C., higher than 40° C., higher than 50° C., higher than 60° C., or higher than 70° C., as measured by ASTM D3418-99, titled “Standard Test Method for Transition Temperatures of Polymers By Differential Scanning Calorimetry,” which is incorporated herein by reference.

In some embodiments, the total luminous transmittance (Tₜ) of the first transparent protecting layer is higher than 50%, higher than 60%, higher than 70%, higher than 80%, or higher than 90%, as measured by ASTM D1003-13, titled “Standard Test Method for Haze and Luminous Transmittance of Transparent Plastics,” which is incorporated herein by reference. In other embodiments, the haze of the first transparent protecting layer is less than 40%, less than 30%, less than 20%, less than 15%, or less than 10%, as measured by ASTM D1003-13.

The first transparent protecting layer can be applied on the surface of the article by any conventional coating method such as dipping into or spraying with a transparent polymer or a ceramic coating disclosed herein for making the first transparent protecting layer. After the application, the coating may be dried or cured at room temperature or an elevated temperature from about 30° C. to about 80° C. for a period of drying time from about 30 minutes to about 24 hours.

The adhesive for the decorative pattern layer can be any conventional adhesive such as non-reactive adhesives and reactive adhesives. Some non-limiting examples of non-reactive adhesives include adhesives that harden by drying (e.g., solvent-based adhesives and polymer dispersion adhesives), pressure-sensitive adhesives, contact adhesives, and hot melt adhesives. Some non-limiting examples of reactive adhesives include one-part adhesives and multi-part adhesives (e.g., 2-part adhesives and 3-part adhesives).

The one-part adhesives can be any adhesives that can harden, without a chemical hardener, via a chemical reaction triggered with an external energy source (e.g., radiation, heat, and moisture). Some non-limiting examples of one-part adhesives include ultraviolet (UV) light curing adhesives, heat curing adhesives, and moisture curing adhesives.

The multi-part adhesives can be any adhesives that can harden by mixing two or more components which chemically react. Some non-limiting examples of multi-part adhesives include epoxy resins, acrylic resins, urethane resins or a combination thereof. In certain embodiments, 2-part adhesives is an epoxy resin, a combination of a polyester resin and a polyurethane resin, a combination of a polyol and a polyurethane resin, or a combination of an acrylic polymer and a polyurethane resin.

In some embodiments, the adhesive is a one-part adhesive free of any chemical hardener. In further embodiments, the one-part adhesive is a heat curing adhesive, moisture curing adhesive, a UV light curing adhesive, or a combination thereof.

In certain embodiments, the adhesive is a two-part adhesive. In further embodiments, the 2-part adhesive is cured at room temperature. In still further embodiments, the adhesive is a 2-part adhesive and wherein the curing step e) is done at room temperature for a time period from 30 minutes to 8 hours.

The decorative pattern layer can be in the form of any design pattern that is suitable for decorating articles such as decorating seashells. The decorative pattern layer can be applied on the surface of the article by any suitable coating method. In some embodiment, the pattern is a unique original design applied on the surface of article with the adhesive disclosed herein by an artist or a designer using a paint brush. In certain embodiment, the pattern is applied on the surface of article with the adhesive disclosed herein using an inkjet printer having a print head that can move in 3 dimensions.

In some embodiments, the area of the decorative pattern layer is less than about 10%, less than about 20%, less than about 30%, less than about 40%, less than about 50%, less than about 60%, or less than about 80% of the total surface area of the article. In certain embodiments, the area of the decorative pattern layer is greater than about 10%, greater than about 20%, greater than about 30%, greater than about 40%, greater than about 50%, greater than about 60%, or greater than about 80% of the total surface area of the article.

Any metal powder that is electroconductive can be used herein for covering the decorative pattern layer. In some embodiments, the metal powder is copper powder, silver powder, gold powder, palladium powder, platinum powder, rhodium powder, tin powder, zinc powder, cadmium powder, chromium powder, nickel powder, or lead powder. In further embodiments, the metal powder is gold powder, silver powder, copper powder, or a combination thereof.

In some embodiments, the covering step d) is done by sprinkling or spraying the metal powder onto the decorative pattern layer. In certain embodiments, the sprinkling is done by hand, a hand tool or a scattering machine. In other embodiments, the sprinkling or spraying step is repeated 1-5 times before the curing step e) to ensure the decorative pattern layer is covered substantially or completely with metal powder.

In certain embodiments, the method disclosed herein further comprises applying pressure on the metal powder in the metal powder layer to cause any loose metal powder to be fixed on the decorative pattern layer. In some embodiments, the applying pressure step is carried out after each sprinkling or spraying step.

In certain embodiments, the average particle size of the metal powder is less than 0.5 mm, less than 0.4 mm, less than 0.3 mm, less than 0.2 mm, less than 0.1 mm, less than 0.05 mm, or less than 0.01 mm. In certain embodiments, the average particle size of the metal powder is greater than the thickness of the decorative pattern layer. In certain embodiments, the average particle size of the metal powder is less than the thickness of the decorative pattern layer.

In certain embodiments, the article with the metal powder layer is cleaned before the forming step f). In some embodiments, the cleaning is done by solvent cleaning, hot alkaline detergent cleaning, electro-cleaning, acid treatment, or a combination thereof.

Any conventional electroplating method that can deposit or coat a continuous layer of a metal on a surface of a conductive substrate or electrode can be used herein. In some embodiments, the electroplating method is electrochemical deposition, pulse electroplating, brush electroplating, or electroless deposition. In certain embodiments, the electroplating method is electrochemical deposition. In certain embodiments, the electroplating method does not include vacuum deposition.

The continuous metal layer can comprises any metals that can be electroplated on a conductive substrate. Some non-limited examples of metals include copper, silver, gold, palladium, platinum, rhodium, tin, zinc, cadmium, chromium, nickel, and lead. In certain embodiments, the metal in the continuous metal layer is copper, silver, gold, palladium, platinum, rhodium or a combination thereof. In other embodiments, the metal in the continuous metal layer is not palladium, platinum or rhodium. In some embodiments, the continuous metal layer is made by electroplating a combination of two or more metals in the same cell. Some non-limited examples of metal combinations include gold, copper and. cadmium; zinc and cobalt; zinc and iron; zinc and nickel; copper and zinc (brass); copper and tin (bronze); tin and zinc; tin and nickel; and tin and cobalt. In certain embodiments, the metal in the continuous metal layer is not a metal combination disclosed herein.

In some embodiments, there are two or more continuous metal layers formed by the electroplating method on the same article surface. In certain embodiments, if two or more continuous metal layers are desired, steps b) to f) are repeated once or more times. The metals in the two or more continuous metal layers can be the same or different. In certain embodiments, the metals in the two or more continuous metal layers are different. In other embodiments, the two or more continuous metal layers do not overlap on the article surface. In further embodiments, the two or more continuous metal layers partially or completely overlap on the article surface.

In certain embodiments, the thickness of the continuous metal layer is from 0.05 microns to 500 microns. In some embodiments, the thickness of the continuous metal layer is greater than 0.05 microns, greater than 0.1 microns, greater than 0.2 microns, greater than 0.3 microns, greater than 0.4 microns, greater than 0.5 microns, greater than 1 microns, greater than 5 microns, or greater than 10 microns. In further embodiments, the thickness of the continuous metal layer is less than 500 microns, less than 400 microns, less than 300 microns, less than 200 microns, less than 100 microns, or less than 50 microns.

In certain embodiments, the method disclosed herein further comprises applying a second transparent protecting layer on the article after the forming step f). The second transparent protecting layer is for protecting the at least one continuous metal layer from damages such as scratches or oxidation. The second transparent protecting layer can be or comprise the transparent polymer or ceramic coating disclosed herein for the first transparent protecting layer. The second transparent protecting layer can be applied on the articles by method disclosed hereon for the first transparent protecting layer.

The second transparent protecting layer can be colorless or colored. In some embodiments, the second transparent protecting layer is colorless. In certain embodiments, the second transparent protecting layer is chemically same as the first transparent protecting layer of step b). In other embodiments, the second transparent protecting layer is chemically different from the first transparent protecting layer.

In another aspect, provided herein is a decorative article such as a decorative seashell prepared by the methods disclosed herein.

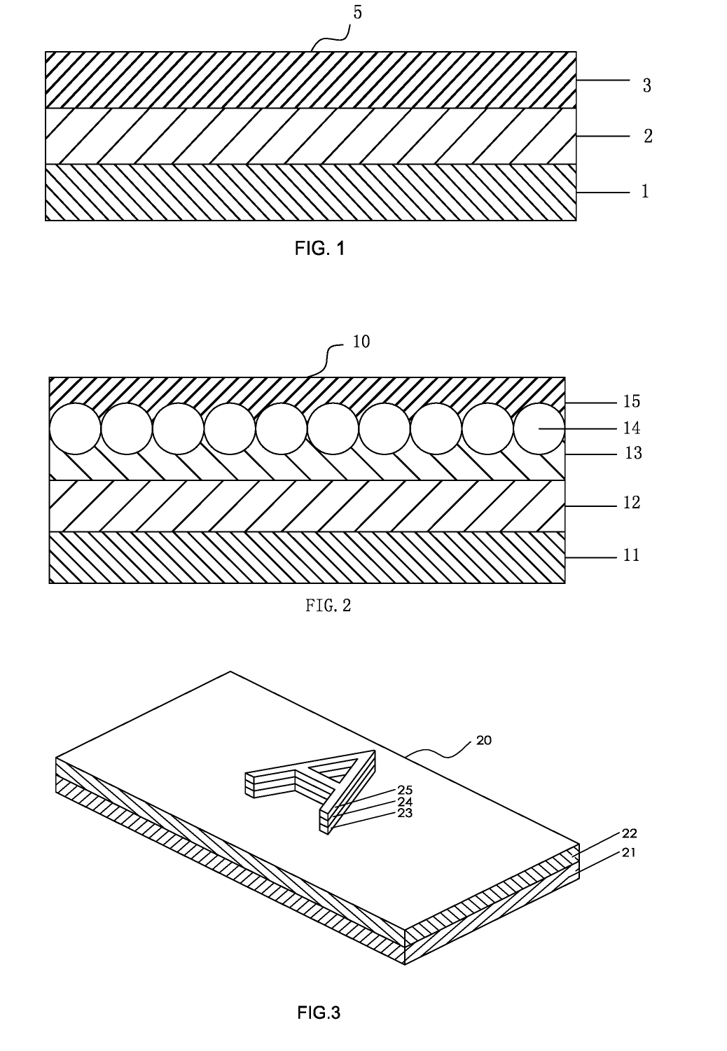

FIG. 1 depicts an embodiment of a decorative article such as seashell (5) prepared by a conventional electroplating method, in which seashell (1) is coated with an electroconductive layer (2), and then a continuous metal layer (3) is electroplated on top of the electroconductive layer (2).

FIG. 2 depicts a first embodiment of a decorative article such as seashell (10) prepared by the method disclosed herein, in which seashell (11) is coated with a first transparent protective layer (12). A decorative pattern layer (13) is painted on the first transparent protecting layer with an adhesive disclosed herein. The decorative pattern layer (13) is covered by metal powder to form a metal powder layer (14) on the decorative pattern layer (13). After the adhesive is cured partially or completely, a continuous metal layer (15) is formed on the metal powder layer (14) by an electroplating method. The continuous metal layer (15) is optionally covered with a second transparent protective layer (not shown).

FIG. 3 depicts a perspective view of a second embodiment of the decorative article such as seashell (20) as shown in FIG. 1, in which seashell (21) is coated with a first transparent protective layer (22) and then the decorative pattern layer (23). The decorative pattern layer (23) is in the form of capital letter A, which is sequentially covered with the metal powder layer (24) and the continuous metal layer (25).

The following examples are presented to exemplify embodiments of the invention. All numerical values are approximate. When numerical ranges are given, it should be understood that embodiments outside the stated ranges may still fall within the scope of the invention. Specific details described in each example should not be construed as necessary features of the invention.

### EXAMPLES

### Example 1

### Decorative Seashell Prepared Without Metal Powder

A seashell was cleaned with an aqueous solution of 5% sulfuric acid in water. After the seashell was air dried at room temperature, the seashell was coated with a clear lacquer (NX-300C, obtained from Shenzhen NanXiang Technology Co., Ltd, Shenzhen, Guangdong Province, China) until the surface of the seashell was fully coated. An electroconductive layer (quick drying type conductive silver paint, obtained from Guangzhou Kaixiang Electronics Co. Ltd., Guangzhou, Guangdong Province, China) was applied on the seashell to form a coated area according to a pattern to be made on the surface of the seashell. The seashell was put into an electro-plating tank having a copper plating solution and a titanium anode. The seashell was connected with the cathode. The copper plating solution contained copper(II) sulfate, sulfuric acid, sodium chloride, CUPRACID® Start-up/A/B (obtained from Atotech, Rock Hill, S.C.), and pure water. A controlled current of 1.5 amperes at 0.5 volts was passed through the seashell and the copper plating solution using a DAZHENG PS-305D rectifier (obtained from Shenzhen Yizhan Electrical Instrument Co. Ltd, Shenzhen, Guangdong Province, China) to form a continuous copper layer on the copper powder layer. After 4 hours of the plating process, the seashell was taken out and rinsed with water to remove any remaining copper plating solution on the seashell. The seashell was air dried to form the decorative seashell of Example 1.

### Example 2

### Decorative Seashell Having a Continuous Copper Layer

A seashell was cleaned with an aqueous solution of 5% sulfuric acid in water. After the seashell was air dried at room temperature, the seashell was coated with a clear lacquer (NX-300C, obtained from Shenzhen Nan Xiang Technology Co., Ltd, Shenzhen, Guangdong Province, China) until the surface of the seashell was fully coated. A 2-part adhesive (W.C.T cold weld glue, obtained from Cheung Wo Metal Co., Kwai Chong, Kowloon, Hong Kong) was prepared by mixing its two components together. The W.C.T. cold weld glue was applied on the seashell to form a coated area according to a pattern to be made on the surface of the seashell. After 30 minutes from the time of mixing the two components, copper powder was applied on the partially cured W.C.T. cold weld glue to fully cover the coated area with a layer of copper powder. Pressure was applied on the copper powder by a spatula or a spoon to make sure any loose copper powder is fixed in the coated area. The W.C.T. cold weld glue was cured together with the copper powder for another 50 minutes at room temperature. After excess and loose copper powder was removed by a sweeper, the seashell was put into the aqueous solution of 5% sulfuric acid in water for 1 minute and then rinsed with water. The seashell was put into an electro-plating tank having a copper plating solution and a titanium anode. The seashell was connected with the cathode. The copper plating solution contained copper(II) sulfate, sulfuric acid, sodium chloride, CUPRACID® Start-up/A/B (obtained from Atotech, Rock Hill, S.C.), and pure water. A controlled current of 1.5 amperes at 0.5 volts was passed through the seashell and the copper plating solution using a DAZHENG PS-305D rectifier to form a continuous copper layer on the copper powder layer. After 4 hours of the plating process, the seashell was taken out and rinsed with water to remove any remaining copper plating solution on the seashell. The seashell was air dried to form the decorative seashell of Example 2.

### Example 3

### Decorative Seashell Having a Continuous Palladium Layer

Example 2 having a continuous copper layer was put into an aqueous solution of 5% sulfuric acid in water for 1 minute and then rinsed with water. Example 2 was put into an electro-plating tank having a palladium plating solution and a titanium anode. Example 2 was connected with the cathode. The palladium plating solution contained Raynolds palladium plating solution (obtained from Sun Wing Technology Company, Lai Chi Kok, Kowloon, Hong Kong). A controlled current of 0.2 amperes at 1 volt was passed through Example 2 and the palladium plating solution using a DAZHENG PS-305D rectifier for 15 seconds to form a continuous palladium layer on the continuous copper layer. The decorative seashell having the continuous palladium layer was taken out and rinsed with water to remove any remaining palladium plating solution on the seashell. The decorative seashell was air dried to form Example 3.

### Example 4

### Decorative Seashell Having a Continuous Gold Layer

Example 3 having a continuous palladium layer was put into an aqueous solution of 5% sulfuric acid in water for 1 minute and then rinsed with water. Example 3 was put into an electro-plating tank having a gold plating solution and a titanium anode. Example 3 was connected with the cathode. The gold plating solution contained AURUNA® 500 LC (obtained from UMS China (Hong Kong), Tsim Sha Tsui, Hong Kong). A controlled current of 0.2 amperes at 1 volt was passed through Example 3 and the gold plating solution using a DAZHENG PS-305D rectifier for 15 seconds to form a continuous gold layer on the continuous palladium layer. The decorative seashell having the continuous gold layer was taken out and rinsed with water to remove any remaining gold plating solution on the seashell. The decorative seashell was air dried to form Example 4.

While the invention has been described with respect to a limited number of embodiments, the specific features of one embodiment should not be attributed to other embodiments of the invention. In some embodiments, the methods may include numerous steps not mentioned herein. In other embodiments, the methods do not include, or are substantially free of, any steps not enumerated herein. Variations and modifications from the described embodiments exist. The appended claims intend to cover all those modifications and variations as falling within the scope of the invention.

What is claimed is:

1. A method of making a decorative article, comprising the steps of:
a) providing an article;
b) coating a first transparent protecting layer on the article;
c) painting a decorative pattern layer on the first transparent protecting layer with an adhesive;
d) covering the decorative pattern layer by metal powder to form a metal powder layer on the decorative pattern layer;
e) curing partially or completely the adhesive to fix the metal powder on the decorative pattern layer; and
f) forming at least one continuous metal layer on the metal powder layer by an electroplating method.

2. The method of claim 1, wherein the electroplating method is electrochemical deposition, pulse electroplating, brush electroplating or electroless deposition.

3. The method of claim 1, wherein the adhesive is a one-part adhesive, a 2-part adhesive or a combination thereof.

4. The method of claim 3, wherein the one-part adhesive is a heat curing adhesive, moisture curing adhesive, a UV light curing adhesive, or a combination thereof, and wherein the 2-part adhesive is cured at room temperature.

5. The method of claim 4, wherein the one-part adhesive is a heat curing adhesive.

6. The method of claim 3, wherein the adhesive is a 2-part adhesive and wherein the curing step e) is done at room temperature for a time period from 30 minutes to 8 hours.

7. The method of claim 1, wherein the metal powder is gold powder, silver powder, copper powder, or a combination thereof.

8. The method of claim 1, wherein the metal in the continuous metal layer is copper, silver, gold, palladium, platinum, rhodium or a combination thereof.

9. The method of claim 1, wherein there are two or more continuous metal layers, and wherein the metals in the continuous metal layers are different.

10. The method of claim 1 further comprising cleaning the article before the coating step b).

11. The method of claim 1, wherein the covering step d) is done by sprinkling or spraying the metal powder onto the decorative pattern layer.

12. The method of claim 11, wherein the sprinkling is done by hand, a hand tool or a scattering machine.

13. The method of claim 11, wherein the sprinkling or spraying step is repeated 1-5 times before the curing step e).

14. The method of claim 1, wherein the article with the metal powder layer is cleaned before the forming step f).

15. The method of claim 13, wherein the cleaning is done by solvent cleaning, hot alkaline detergent cleaning, electro-cleaning, acid treatment, or a combination thereof.

16. The method of claim 1, wherein the area of the decorative pattern layer is less than about 10%, less than about 20%, less than about 30%, less than about 40%, less than about 50%, less than about 60%, or less than about 80% of the total surface area of the article.

17. The method of claim 1, wherein the thickness of the continuous metal layer is from 0.05 microns to 500 microns.

18. The method of claim 1, wherein the average particle size of the metal powder is less than 0.5 mm.

19. The method of claim 17, wherein the average particle size of the metal powder is greater than or less than the thickness of the decorative pattern layer.

20. The method of claim 1 further comprising applying a second transparent protecting layer on the article after the forming step f).

21. The method of claim 1, wherein the article is a seashell.

22. A decorative article prepared by the method of claim 1.

23. The decorative article of claim 22, wherein the decorative article is a decorative seashell.
